(19) United States
(12) Patent Application Publication
(10) Pub. No.: US 2015/0354262 A1
(43) Pub. Date: Dec. 10, 2015

(54) Safe with Latch and Key Lock

(71) Applicant: Leslie Ho Leung Chow, Shilouzhen Panyu District (CN)

(72) Inventor: Leslie Ho Leung Chow, Shilouzhen Panyu District (CN)

(21) Appl. No.: 14/297,451

(22) Filed: Jun. 5, 2014

(51) Int. Cl. E05G 1/04; E05G 1/026

(52) U.S. Cl. CPC E05G 1/04; E05G 1/026

(57) ABSTRACT

A safe. A safe lid is connected to a safe box via a hinge. A fascia assembly is connected to the safe lid and a latch assembly is connected to the safe box. The fascia assembly includes a keypad and a fascia assembly locking groove. The latch assembly includes a latch having a fascia assembly locking tab and a lock latch locking tab. The latch assembly also has a lock lever pivotally connected to the latch and the latch assembly. A motor in the latch assembly receives electrical inputs from the keypad. The latch assembly also has a key lock. A lock latch is connected to and controlled by the motor and the key lock. A lock latch reset spring is connected to the lock latch. The safe is locked when the fascia assembly locking tab is inserted into the fascia assembly locking groove and also when the lock latch locking tab is secured behind the lock latch. The safe is unlocked by entering a pass code into the key pad. This caused an electrical signal to be transmitted to the motor. The motor then operates to move the lock latch so that it releases the lock latch locking tab. The safe can also be opened by turning the key lock to move the lock latch so that it releases the lock latch locking tab.

The present invention relates to safes, and in particular, to locking systems for safes.

### BACKGROUND OF THE INVENTION

Safe boxes (also known as “safes”) are well known in the prior art. They are used primarily to protect documents, currency, jewelry, and other valuables from fire and theft. Stand alone safes are very common in homes and businesses throughout the world. A fire-resistant safe (also known as a “fireproof safe” or a “fire safe”) is a type of safe that is designed to protect its contents from high temperatures or actual fire. There are various types of locking mechanisms currently being utilized for safes that incorporate known technologies.

Nitinol Wire

Nitinol Wire (also known as ‘Muscle Wire’ or ‘Memory Wire’) is a thin strand of a special shape memory alloy composed primarily of Nickel (Ni) and Titanium (Ti). Nitinol Wire will shorten in length after receiving an electrical signal, or heated by other means. Nitinol wire returns to its original length the electrical signal is removed and/or cooled.

What is needed is a better safe that allows operation through a user controlled keypad as well as a backup operation via a hand held key.

### SUMMARY OF THE INVENTION

The present invention provides a safe. A safe lid is connected to a safe box via a hinge. A fascia assembly is connected to the safe lid and a latch assembly is connected to the safe box. The fascia assembly includes a keypad and a fascia assembly locking groove. The latch assembly includes a latch having a fascia assembly locking tab and a lock latch locking tab. The latch assembly also has a lock lever pivotally connected to the latch and the latch assembly. A motor in the latch assembly receives electrical inputs from the keypad. The latch assembly also has a key lock. A lock latch is connected to and controlled by the motor and the key lock. A lock latch reset spring is connected to the lock latch. The safe is locked when the fascia assembly locking tab is inserted into the fascia assembly locking groove and also when the lock latch locking tab is secured behind the lock latch. The safe is unlocked by entering a pass code into the key pad. This caused an electrical signal to be transmitted to the motor. The motor then operates to move the lock latch so that it releases the lock latch locking tab. The safe can also be opened by turning the key lock to move the lock latch so that it releases the lock latch locking tab.

### BRIEF DESCRIPTION OF THE DRAWINGS

FIGS. 1A-1C show a preferred embodiment of the present invention.

FIGS. 2A-2B shows perspective views of components of a preferred latch assembly.

FIGS. 2C-2D show the operation of a preferred embodiment of the present invention.

FIG. 3 shows another perspective view of components of a preferred latch assembly.

FIG. 4 shows a preferred embodiment of the present invention.

FIG. 4B shows the walls of a preferred fireproof safe.

FIG. 5 shows another preferred embodiment of the present invention.

FIGS. 6A-6C show another preferred embodiment of the present invention.

FIGS. 7A-7C show another preferred embodiment of the present invention.

### DETAILED DESCRIPTION OF THE PREFERRED EMBODIMENTS

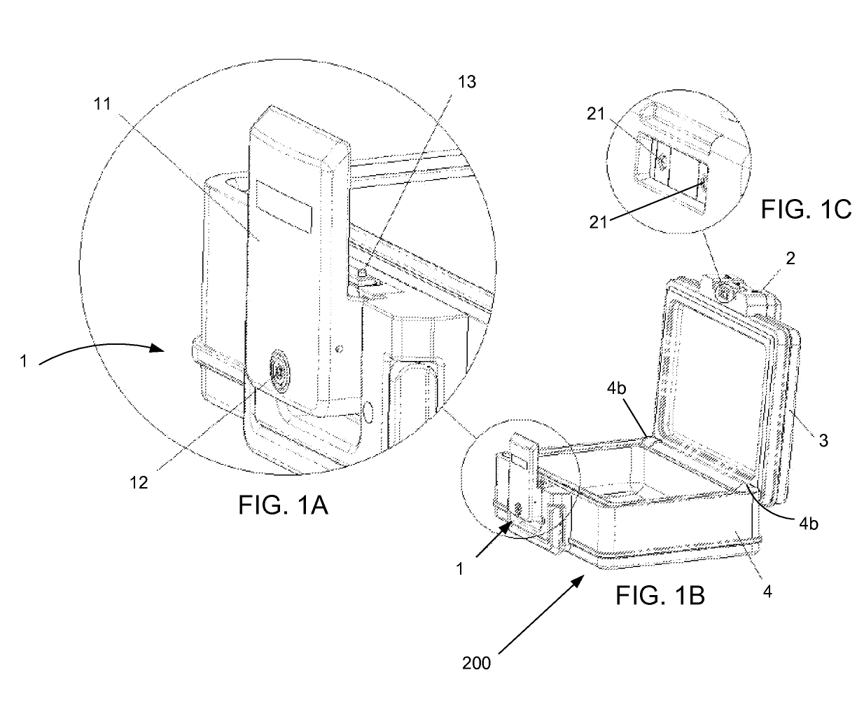

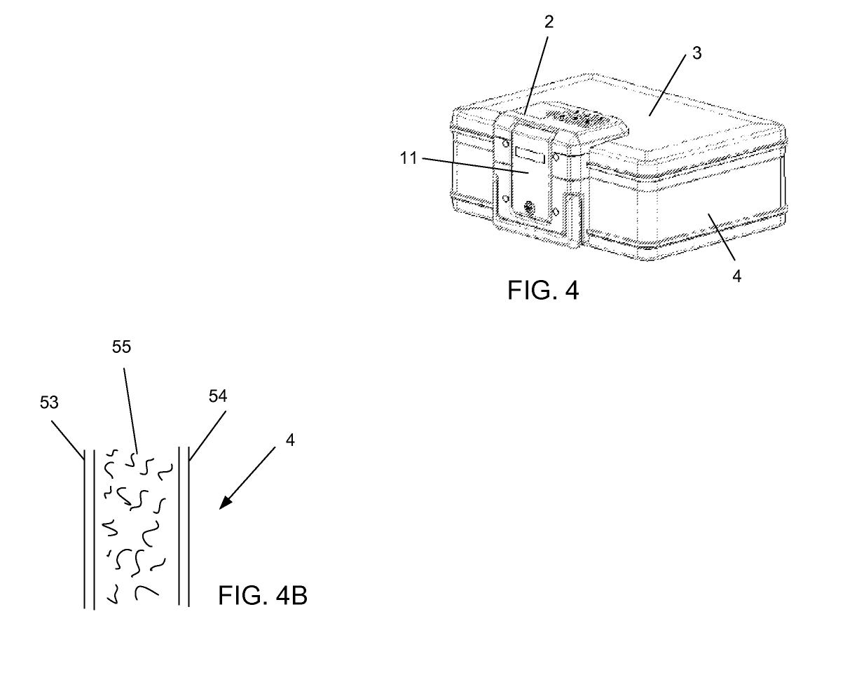

Chest 200 includes latch assembly 1, fascia assembly 2, lid 3 and box 4 (see FIG. 1B and FIG. 4). Latch assembly 1 is connected to box 4 and fascia assembly 2 is connected to lid 3. Lid 3 is connected via hinges 4b to box 4.

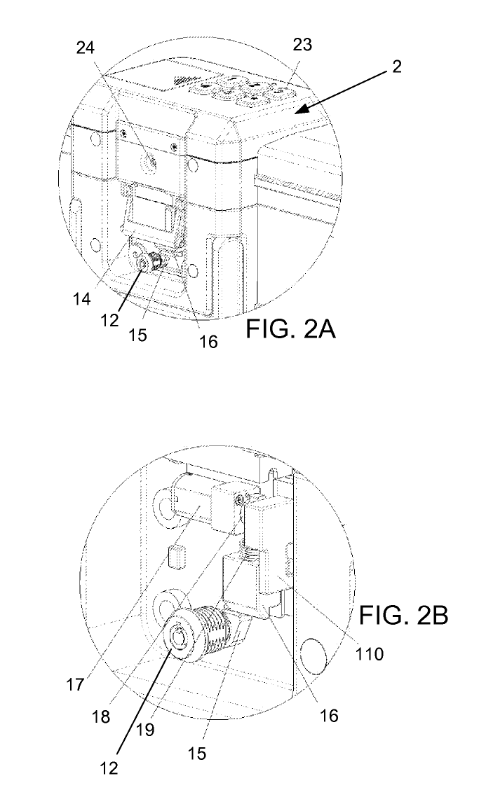

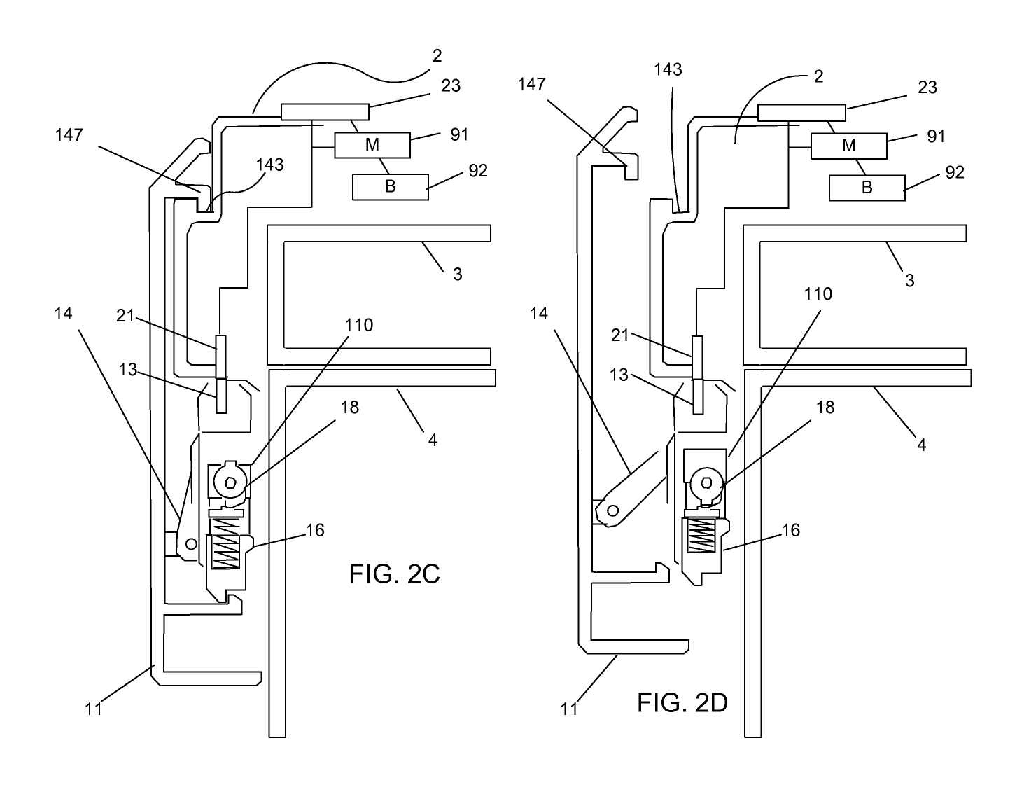

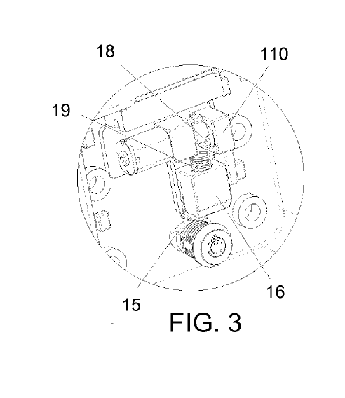

Lid 3 and box 4 are locked together via latch 11. When latch 11 is in the closed position, it is locked down by lock latch 16 (see FIGS. 2A-2C). Locking tab 147 of latch 11 engages groove 143 of fascia assembly 2 to lock lid 3 down onto box 4.

Using a Key Pad to Unlock the Safe

As shown in FIGS. 2C-2D, key pad 23 is attached to fascia assembly 2. Pass code reset button 24 (see FIG. 2A) and electrode plates 21 (FIG. 1C) are also connected to fascia assembly 2. Fascia assembly 2 is powered by battery 92 and controlled by microprocessor 93. When chest 200 is closed, the user enters the pass code using key pad 23. Power is then transmitted via electrode plates 21 to electrode rods 13 (FIG. 1A) on latch assembly 1 and through to motor 17 (FIGS. 2B-2D). Gear 18 on motor 17 rotates 180 degrees, which moves gear connecting plate 110 upwards and in turn pushes lock latch 16 upwards against lock lever 14 (FIG. 2D) and releases latch 11 (FIG. 1A, 1B and 2D) from fascia assembly 2.

Using a Key Lock to Unlock the Safe

As an alternative, key lock 12 may be utilized to unlock safe 200. For example, as shown in FIGS. 2A-2D, key 12 is turned counterclockwise causing lock plate 15 to push upwards on lock latch 16. Lock latch 16 likewise pushes upwards on lock lever 14 and releases latch 11 from fascia assembly 2 (FIG. 2D). Key lock 12 is turned clockwise to reset. Compressed lock plate reset spring 19 pushes lock plate 16 to its original position.

The Latch Moving to the Lock Position

When lid 3 is closed, microprocessor 93 sends a signal to motor 17 to turn gear 18 180 degrees so that gear connecting plate 110 is moved to its original position. Compressed lock latch reset spring 19 pushes lock latch 16 to its original position. The user pushes latch 11 down against groove 143 on fascia assembly 2 and pushes latch 11 in towards box 4. Lock latch 16 slides into latch 11 and locks.

Other Possible Actuators for the Motor

As stated above, gear 18 on motor 17 rotates 180 degrees, which moves gear connecting plate 110 upwards and in turn pushes lock latch 16 upwards against lock lever 14 (FIG. 2D) and releases latch 11 (FIGS. 1A, 1B and 2D) from fascia assembly 2. It should be noted that motor 17 can be replaced by other types of actuators that function to move lock latch 16 upwards to clear latch 11.

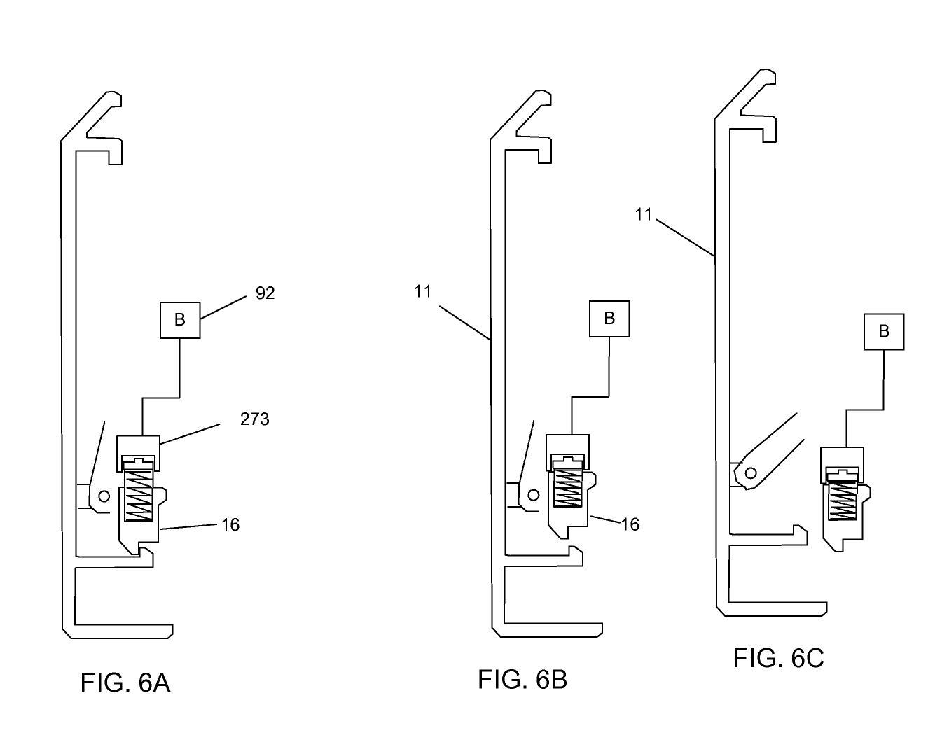

For example, FIGS. 6A-6C show the utilization of solenoid 273 to move latch 16 upwards. In FIG. 6A, an electrical signal from battery 92 has been transmitted to solenoid 273 causing lock latch 16 to move upwards as shown in FIG. 6B. Lock latch 11 is now clear and opens as shown in FIG. 6C.

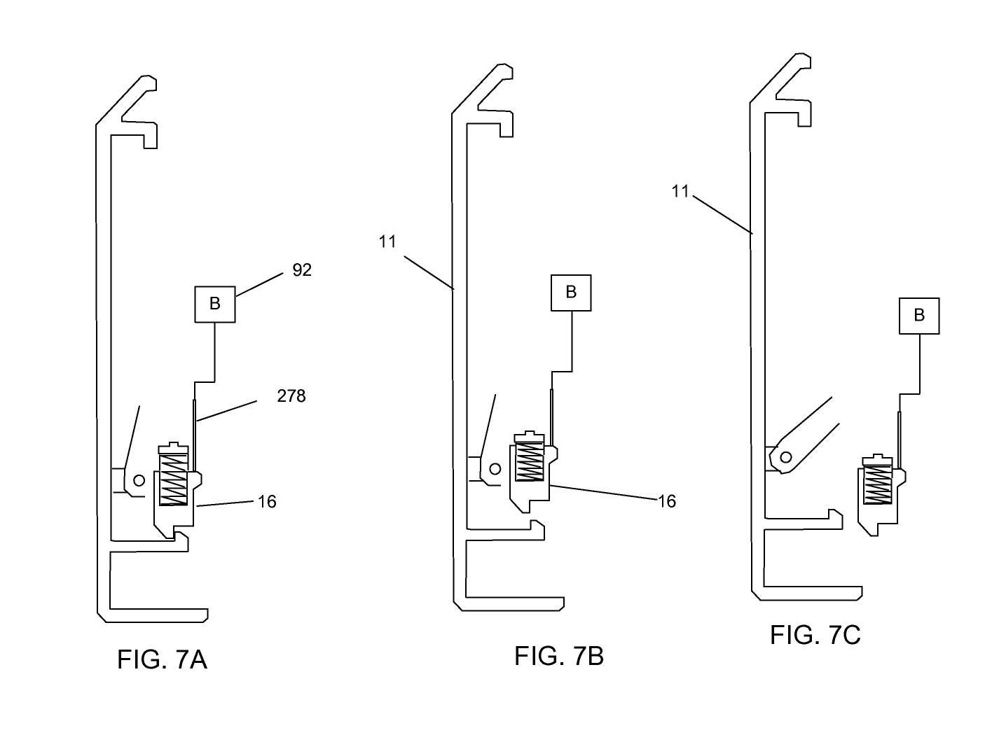

Also, FIGS. 7A-7C show the utilization of nitinol wire 278 to move latch 16 upwards. In FIG. 7A, an electrical signal from battery 92 has been transmitted to nitinol wire 278 causing it to shorten and then causing lock latch 16 to move upwards as shown in FIG. 7B. Lock latch 11 is now clear and opens as shown in FIG. 7C.

### Other Embodiments

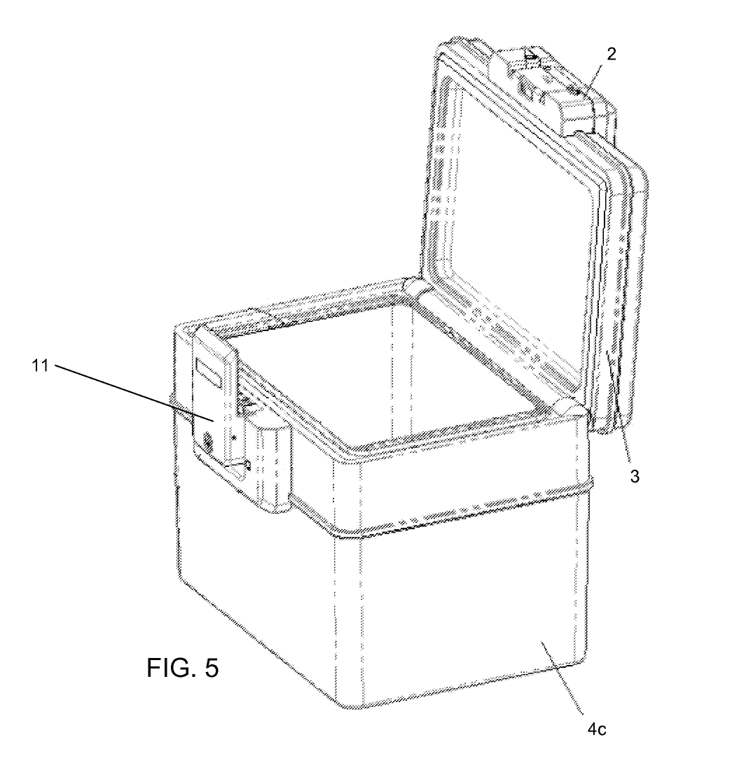

FIG. 5 shows another preferred embodiment having a larger box 4c for more storage capacity. FIG. 4B shows that safe 200 can be a fireproof safe. For example box 4 includes interior wall 54 and exterior wall 53 with fireproof insulation 55 between. To make safe 200 a fireproof safe, all walls of box 4 and lid 3 include insulation 53 sandwiched between interior and exterior walls. Also, it should be noted that box 4 and lid 3 can be fabricated from either plastic or metal.

Although the above-preferred embodiments have been described with specificity, persons skilled in this art will recognize that many changes to the specific embodiments disclosed above could be made without departing from the spirit of the invention. For example, it would be possible to modify the present invention so that fascia assembly 2 unlocks a separate mechanism that allows the user to then manually unlock the latch. The user could then manually unlock the safe by pressing a button or turning a knob, for example. Therefore, the attached claims and their legal equivalents should determine the scope of the invention.

What is claimed is:

1. A safe, comprising:
A. a safe lid,
B. a safe box connected to said safe lid via a hinge,
C. a fascia assembly connected to said safe lid, said fascia assembly comprising:
A. a keypad,
B. a fascia assembly locking groove,
D. a latch assembly connected to said safe box, said latch assembly comprising:
A. a latch, comprising:
1. a fascia assembly locking tab,
2. a lock latch locking tab,
B. a lock lever pivotally connected to said latch and said latch assembly,
C. a motor receiving electrical inputs from said key pad,
D. a key lock,
E. a lock latch connected and controlled by said motor and said key lock,
F. a lock latch reset spring connected to said lock latch,
wherein said safe is locked when said fascia assembly locking tab is inserted into said fascia assembly locking groove and said lock latch locking tab is behind said lock latch, wherein said safe is opened by entering a pass code into said key pad causing an electrical signal to transmit to said motor causing said lock latch to release said lock latch locking tab, wherein said safe is opened by turning said key lock causing said lock latch to release said lock latch locking tab.

2. The safe as in claim 1, wherein said fascia assembly further comprises:
A. a microprocessor,
B. a battery for powering said microprocessor, and
C. at least one electrode plate electrically connected to said keypad and microprocessor.

3. The safe as in claim 2, wherein said latch assembly further comprises:
A. an electrode rod electrically connected to said electrode plate, wherein said motor is electrically connected to said electrode rod,
B. a gear connected to said motor, and
C. a connecting plate connected to said gear, wherein said lock latch is connected to said connecting plate.

4. The safe as in claim 1, wherein said safe is a fire safe.

5. The safe as in claim 1, wherein said safe is fabricated from plastic.

6. The safe as in claim 1, wherein said safe is fabricated from metal.

7. A safe, comprising:
A. a safe lid,
B. a safe box connected to said safe lid via a hinge,
C. a fascia assembly connected to said safe lid, comprising:
A. a keypad,
B. a microprocessor,
C. a battery for powering said microprocessor, and
D. at least one electrode plate electrically connected to said keypad and microprocessor,
E. a fascia assembly locking groove
D. a latch assembly connected to said safe box, said latch assembly comprising:
A. a latch, comprising:
1. a fascia assembly locking tab,
2. a lock latch locking tab,
B. a lock lever pivotally connected to said latch and said latch assembly,
C. an electrode rod electrically connected to said electrode plate,
D. a motor, electrically connected to said electrode rod,
E. a gear connected to said motor,
F. a connecting plate connected to said gear,
G. a lock latch connected to said connecting plate,
H. a key lock comprising a lock plate, said lock plate in contact with said lock latch,
I. a lock latch reset spring connected to said lock latch,
wherein said safe is locked when said fascia assembly locking tab is inserted into said fascia assembly locking groove and said lock latch locking tab is behind said lock latch, wherein said safe is opened by entering a pass code into said key pad causing an electrical signal to transmit to said motor causing said lock latch to release said lock latch locking tab, wherein said safe is opened by turning said key lock causing said lock latch to release said lock latch locking tab.

8. A safe, comprising:
A. a safe lid,
B. a safe box connected to said safe lid via a hinge,
C. a fascia assembly connected to said safe lid, said fascia assembly comprising:
A. a keypad,
B. a fascia assembly locking groove,
D. a latch assembly connected to said safe box, said latch assembly comprising:
A. a latch,
B. a lock lever pivotally connected to said latch and said latch assembly,
C. a motor receiving electrical inputs from said key pad,
D. a key lock,
E. a lock latch connected and controlled by said motor and said key lock, and
F. a lock latch reset spring connected to said lock latch,
